(19) United States
(12) Patent Application Publication
(10) Pub. No.: US 2009/0039786 A1
(43) Pub. Date: Feb. 12, 2009

(54) COMPACT INCANDESCENT LAMP WITH INTEGRATED REFLECTOR

(75) Inventors: Walter Schlager, Bocholtz (NL); Ludo Haenen, Sint Oedenrode (NL); Benno Spinger, Aachen (DE); Jorrit Ernst De Vries, Culemborg (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,403

(22) PCT Filed: Oct. 26, 2005
(86) PCT No.: PCT/IB05/53497

§ 371 Date: May 2, 2007

(30) Foreign Application Priority Data
Nov. 9, 2004 (EP) 04105608.6

(51) Int. Cl. H01J 61/35

(52) U.S. Cl. 313/635

(57) ABSTRACT

The invention relates to a compact incandescent lamp with an integrated reflector, comprising at least a lamp bulb, on one part of the surface of which the reflector is applied as a reflective layer and another part thereof is a light output window, an incandescent element, which is arranged in a defined way in the lamp bulb and is positioned in a defined way with respect to the reflective layer, wherein at least the part of the lamp bulb which carries the reflective layer is non-axisymmetric and/or a part of the light output window is asymmetrically shaped, so that the visible light which the lamp can generate illuminates a region of space non-axisymmetrically.

The invention relates to a compact incandescent lamp with an integrated reflector, comprising at least a lamp bulb, on one part of the surface of which the reflector is applied as a reflective layer and another part thereof is a light output window, and an incandescent element, which is arranged in a defined way in the lamp bulb and is positioned in a defined way with respect to the reflective layer.

Besides the two aforementioned regions, there may be at least one further region on the lamp bulb.

Lamps of the aforementioned type, which need to have an axisymmetric lamp bulb owing to their function, have been known for many years. This is due in particular to the very effective way in which such axisymmetric lamp bulbs can be produced in the scope of industrial mass production.

For many applications, lamps with such a bulb generate light that illuminates a region of space, in particular uniformly but in any event axisymmetrically.

If non-axisymmetric illumination is required for other applications, this is achieved using further optical components, for example lenses or reflectors with an appropriate geometry, which are arranged in the relevant beam path, i.e. according to requirements by an appropriate illumination unit. These further optical components entail additional costs and often an additional space requirement. For a particular lamp power, a power-dependent minimum space requirement is generally demanded of such an illumination unit.

Illumination units having an incandescent lamp with an integrated reflector, comprising at least a lamp bulb, on one part of the surface of which the reflector is applied as a reflective layer and another part thereof is a light output window, and an incandescent element, which is arranged in a defined way in the lamp bulb and is positioned in a defined way with respect to the reflective layer, have a comparatively small minimum space requirement.

Such an incandescent lamp is known, for example, from U.S. Pat. No. 6,140,769. The lamp bulb of this lamp does not have a pinch seal, but is hermetically connected to the lamp bulb in particular by a molded glass plate. The incandescent element is furthermore fastened on this glass plate. In this type of lamp, the incandescent element is arranged in a defined way in the lamp bulb and therefore also positioned in a defined way with respect to the reflective layer. The reflective layer is applied on the axisymmetric lamp bulb and is used as a reflector.

Such lamps can be used for vehicle lighting, for example, and in this context particularly in illumination units as taillights, reversing lights and the like.

Lamps which are intended to be used for a vehicle's exterior lighting, for example headlamps and signaling lights, are subject to international standards with respect to their most important parameters, for example the SAE standards and the ECE regulations, which relate essentially to the European or USA market. For example, the color properties to be complied with in each case are exactly defined. (One of these parameters is the so-called color point of the emitted light, which can be represented for example by a CIE 1931 diagram.)

There are furthermore minimum requirements for a signaling light beam according to these standards.

ECE regulations 6 and 7, for example, stipulate at the beam center for the following non-axisymmetric applications:

Brake light (ECE R7, cat. S1) 60 cd (red light, corresponding to about 300 cd of white light)

Rear indicator light (ECE R6, cat. 2a) 50 cd (yellow light, corresponding to about 83 cd of white light), and

Front indicator light (ECE R6, cat. 1) 175 cd (yellow light, corresponding to about 292 cd of white light).

The aforementioned color positions are regularly achieved by filtering the white incandescent lamp light.

For the aforementioned applications in vehicle lighting, there is a need for more compact illumination units, or in this regard design possibilities for non-axisymmetric illumination.

It is an object of the invention to provide an incandescent lamp, and an illumination unit having such an incandescent lamp, which can be configured more compactly in relation to a particular lamp power and with non-axisymmetric illumination, and which can be produced in the scope of industrial mass production.

The object of the invention is achieved by the features as claimed in claim 1.

What is essential according to the invention is that at least the part of the lamp bulb which carries the reflective layer is non-axisymmetric and/or a part of the light output window is asymmetrically shaped. The effect achieved by this is that the visible light which the lamp can generate illuminates a region of space in particular uniformly but non-axisymmetrically. In order to generate the non-axisymmetric, optionally asymmetric illumination, no further optical components such as lenses or reflectors with appropriate geometries are required when the solution according to the invention is employed.

In order to ensure such illumination reproducibly in the scope of industrial mass production, it is expedient to adhere to a defined arrangement of the reflector and incandescent element and defined shaping of the lamp bulb, while complying with particular maximum tolerances.

The respective non-axisymmetric, and optionally asymmetric, geometry of the lamp bulb and/or the light output window should in this case be determined as a function of the shape of the non-axisymmetric or asymmetric illumination in a manner which is known per se, by using the known laws of optics.

The dependent claims relate to advantageous refinements of the invention.

Preferably, the reflective layer is an interference filter, which transmits in particular the IR light component. The generally undesirable IR component of the emitted light can therefore be at least reduced with respect to the radiation of the lamp.

Also preferably, a colored translucent coating, in particular one which is red or yellow, is applied on the lamp bulb in the region of the light output window.

The aforementioned preferred configurations may also be used in combination according to the invention.

Preferably, an interference filter is furthermore arranged on the lamp bulb in the region of the reflector. This also provides the opportunity to transmit a part of the light through this special interference coating and therefore achieve a special lighting design.

The invention is also achieved by an illumination unit which contains at least one incandescent lamp as claimed in claims 1 to 5.

These and other aspects of the invention are apparent from and will be elucidated with reference to two preferred embodiments and figures described hereinafter.

In the drawings:

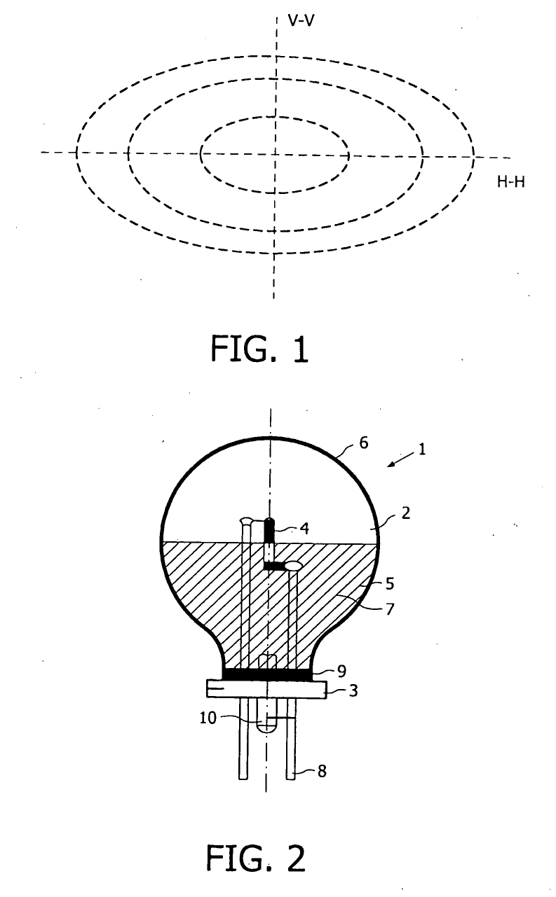

FIG. 1 shows a schematic representation of non-axisymmetric illumination, and

FIG. 2 shows a schematic side view of an incandescent lamp according to the invention.

FIG. 1 shows a schematic representation of non-axisymmetric illumination.

FIG. 2 represents an incandescent lamp 1 according to the invention in a schematic side view. The non-axisymmetric lamp bulb 2 is hermetically connected to the lamp bulb 2 by means of enamel 9, in particular using a molded glass plate 3. The incandescent element 4 is furthermore fastened on this glass plate 3. There are technical manufacturing tolerances as regards the positioning of the glass plate 3 with respect to the incandescent element 4, i.e. about +/−0.25 mm in the axial direction and about +/−0.2 mm laterally. The incandescent element 4 is connected to the two contacts 8, which are hermetically fed through the glass plate 3. The metal tube 10 is likewise-fed hermetically through the glass plate 3.

In this type of lamp, the incandescent element 4 is arranged in a defined way in the lamp bulb 2 and therefore also positioned in a defined way with respect to the reflective layer 5.

The reflective layer 5, represented by shading in FIG. 2, is applied on a part of the non-axisymmetric lamp bulb 2 and is used as a reflector. This reflective layer 5 is a per se conventional interference filter 7, which transmits in particular the IR light component. The remaining part of the surface of the lamp bulb 2 is the light output window 6, on which a per se conventional colored translucent coating is applied.

The gas filling in the lamp bulb 2 contains Xe, Kr, or a mixture of these, which in particular may contain N₂. At room temperature, there is a gas pressure of about 3 to 5 bar in the lamp bulb 2. The metal tube 10 is likewise fed hermetically through the glass plate 3.

The lamp has an electrical power of about 16 W, its incandescent element emitting about 300 lm of white light. The minimum signaling light beam required e.g. for the brake light according to ECE regulation 7, category S1, is satisfied even without further optical components.

Such lamps can be used for vehicle lighting, for example, and in this context particularly in illumination units as taillights, reversing lights and the like.

1. A compact incandescent lamp with an integrated reflector, comprising at least a lamp bulb (2), on one part of the surface of which the reflector is applied as a reflective layer (5) and another part thereof is a light output window (6), an incandescent element (4), which is arranged in a defined way in the lamp bulb (2) and is positioned in a defined way with respect to the reflective layer (5), characterized in that at least the part of the lamp bulb (2) which carries the reflective layer (5) is non-axisymmetric and/or a part of the light output window (6) is asymmetrically shaped, so that the visible light which the lamp (1) can generate illuminates a region of space non-axisymmetrically.

2. An incandescent lamp as claimed in claim 1, characterized in that the reflective layer (5) is an interference filter (7), which transmits in particular the IR light component.

3. An incandescent lamp as claimed in claim 2, characterized in that an interference filter is arranged on the light output window (6).

4. An incandescent lamp as claimed in claim 1, characterized in that a colored translucent coating, in particular one which is red or yellow, is applied on the lamp bulb in the region of the light output window (6).

5. An incandescent lamp as claimed in claim 1, characterized in that an interference filter is arranged on the lamp bulb (2) in the region of the reflector.

6. An illumination unit having at least one incandescent lamp as claimed in claim 1.
